(19) United States
(12) Patent Application Publication
(10) Pub. No.: US 2020/0331109 A1
(43) Pub. Date: Oct. 22, 2020

(54) TOOL MAGAZINE MODULE OF MACHINE TOOL

(71) Applicant: HYUNDAI WIA CORPORATION, Changwon-si, Gyeongsangnam-do (KR)

(72) Inventors: Dal Ho LEE, Seoul (KR); Dennis KORFF, Bibensheim (DE); Erik NOWAK, Mannheim (DE); Thomas SCHNEIDER, Riedstadt (DE)

(21) Appl. No.: 16/766,869

(22) PCT Filed: May 31, 2018
(86) PCT No.: PCT/KR2018/006224

§ 371 Date: May 26, 2020

(30) Foreign Application Priority Data
Nov. 30, 2017 (KR) 10-2017-0163014

(51) Int. Cl. B23Q 3/155

(52) U.S. Cl. CPC B23Q 3/15534; B23Q 2003/1553

(57) ABSTRACT

A tool magazine module of the machine tool is disclosed. The tool magazine module includes: a rotary shaft rotating by being connected to a drive part providing a rotational force; a plurality of magazine bases having a disk shape and being provided with a central part connected to a rotary shaft to be rotated, the plurality of magazine bases loaded with a tool along a rim thereof, and mounted by being stacked on the rotary shaft; and a transfer system enabling the tools to be interchanged between any magazine base and a tool changer by moving in an up-and-down direction and a forward-and-backward direction on one side of the magazine base.

### TECHNICAL FIELD

The present invention relates to a tool magazine of an automatic tool-change system of a machine tool and, more particularly, to a tool magazine module of a machine tool provided with one or more magazine disks.

### BACKGROUND ART

Among machine tools, a machining center (MC) equipped with an automatic tool changer (ATC) is a kind of all-purpose machine tool capable of changing tools as needed and performing various kinds of machining with one machine, such as drilling, boring, screwing, and face-cutting. Machining is numerically controlled by a controller, and by inputting required design data, an automatic programming device makes an NC tape containing information about the sequence of machining, whereby machining is performed automatically.

The automatic tool changer includes a tool magazine loaded with a plurality of tools, and applies a method of moving a tool in the tool magazine to a new position and exchanging the tool with a tool in a main shaft using a tool-change system.

Tool magazines of a tool-receiving system are classified into drum magazines, chain magazines, disk magazines, and ring magazines depending on the structure thereof.

The chain-type tool magazine has an advantage of accommodating an increased number of tools, but has a disadvantage of requiring more time (i.e. chip-to-chip time) and installation space for changing the tools. In contrast, the disk-type tool magazine is limited with regard to the number of tools capable of being loaded therein, but has a benefit in that the time required to exchange tools is short.

In order for the tools to be changed in the automatic tool changer, a mechanism for moving and changing the tools between the tool magazine and the main shaft is required. Depending on requirements for work and the surrounding environment, the mechanism may be composed of rotational movement of the tool magazine, coupling through the movement of the main shaft (i.e. pickup type), a twin arm, or a robot, etc.

The mounting position of the automatic tool changer is a very important factor in the design of the machine tool because the position greatly affects the accessibility and movement of operators and the area required for installation of the machine tool. The mounting position may be the upper part of the main shaft or the upper part or the side part of the column. Alternately, in some cases, the automatic tool changer is embodied separately from the machine tool body. Like the mounting position of the automatic tool changer, the shape of the tool magazine is also influenced by the structure of the main body, the storage capacity of the tool magazine (the number of tools loaded therein), the installation space, and the like. Basically, it is possible for the tool magazine to have various shapes such as those of cylinders, cones, ellipses, and rectangles.

In other words, since the structure or mounting position of the automatic tool changer applied to each machine tool varies, the concept of the automatic tool changer may also vary. This means that for each machine tool, a standardized automatic tool-change system is not applied, but rather a specialized system for the machine tool should be provided. Due to this process, in fact, a lot of cost and effort are required to design and manufacture individual tool magazines.

The foregoing is intended merely to aid in the understanding of the background of the present invention, and is not intended to mean that the present invention falls within the purview of the related art that is already known to those skilled in the art.

The related art may be referred to KR10-1586501 (B).

### DISCLOSURE

### Technical Problem

The present invention is disclosed to solve these problems, and an objective of the present invention is to provide a tool magazine module for a machine tool, wherein the structure of the disk-type tool magazine in tool magazines is modularized, so that various needs of users may be easily met and the cost of development and production of the tool magazine may be reduced, and wherein a standardized system capable of applying one tool magazine to various types of tool-change systems is applied, so that the efficiency of the disk magazine may be maximized through the compact structure and the short change time for tools.

### Technical Solution

In order to achieve the above objective of the present invention, there is provided a tool magazine module of a machine tool, the tool magazine module including: a rotary shaft rotating by being connected to a drive part providing a rotational force; a plurality of magazine bases having a disk shape and being provided with a central part connected to the rotary shaft to be rotated, the plurality of magazine bases loaded with tools along a rim thereof, and mounted by being stacked on the rotary shaft; and a transfer system enabling the tools to be interchanged between any magazine base and a tool changer by moving in an up-and-down direction and a forward-and-backward direction on one side of the magazine base.

The tools may be loaded vertically with respect to the magazine base, so that neighboring tools may be provided in close contact with each other.

The magazine base may be provided in a ring shape having a cavity, the rotary shaft may be inserted into the cavity and be rotatably connected thereto, and the rotary shaft may be provided with a support part extending radially from the rotary shaft to the magazine base and connecting therebetween so as to support rotation of the magazine base.

The magazine base may be provided with the rotary shaft for rotating the magazine base by insertion through the plurality of magazine bases, and the drive part may be provided with a drive shaft that is rotated when driving the drive part; wherein the drive shaft and the rotary shaft may be connected, so that the plurality of magazine bases may rotate simultaneously when driving the drive part.

The magazine base may be provided with a frame that wraps and supports the magazine bases, stacked in a plurality thereof, and extending in an up-and-down direction from an outer side or periphery of the magazine bases.

The frame may be provided with a transverse frame positioned between the magazine bases stacked and extending toward the rotary shaft in a direction crossing the rotary shaft, and the rotary shaft may be inserted through the transverse frame, so that the rotary shaft may be supported by the transverse frame when driving the drive part and be rotated while a center of rotation is maintained.

A bearing part may be provided at a position between the rotary shaft and the transverse frame to enable rotation of the rotary shaft inserted into the transverse frame.

A support plate may be provided at a position below the frame, the support plate may be provided to maintain the center of rotation when rotating the drive part, and the drive part may be vertically connected to the rotary shaft provided through the plurality of magazine bases; and wherein, when more than a predetermined number of magazine bases is stacked, another rotary shaft may be provided to penetrate vertically through and be connected to the transverse frame to maintain the center of rotation, so that, when driving the drive part, the plurality of magazine bases in a vertically stacked state may be rotated while maintaining the center of rotation.

The tool changer may be positioned on an outer side of the frame, and the machine tool may be positioned on an outer side of the tool changer, and wherein both the tool changer and the machine tool may be mounted on the frame and connected to the magazine base.

At least half of the magazine base may be inserted into the machine tool and coupled thereto.

A base plate may be provided at a position below the magazine base to collect leftover cutting oil that drops when changing the tools.

### Advantageous Effects

According to a tool magazine module of a machine tool having the structure described above, regardless of whether an automatic tool changer is implemented as a twin-arm type or a pickup type, there is a benefit in that the tool magazine module may be applied without any design change. In particular, in the case of the twin-arm type, simply by increasing or decreasing the number of magazine bases, there is a benefit of improving the limited tool capacity, which is a disadvantage of the conventional disk magazine. Therefore, the diversity of the product may be maintained while reducing the development and production cost of the magazine base. Also, the tool magazine module has a benefit in that it is capable of being easily applied to any machine tool merely by changing a stacked number thereof depending on the size and shape of the machine tool.

### DESCRIPTION OF DRAWINGS

FIG. 1 is a view illustrating a tool magazine module of a machine tool according to a first exemplary embodiment of the present invention.

FIG. 2 is a side view of FIG. 1.

FIG. 3 is a view illustrating the tool magazine module of the machine tool according to a second exemplary embodiment of the present invention.

FIG. 4 is a side view of FIG. 3.

### MODE FOR INVENTION

Hereinafter, a tool magazine module of a machine tool according to a preferred exemplary embodiment of the present invention will be described with reference to the accompanying drawings.

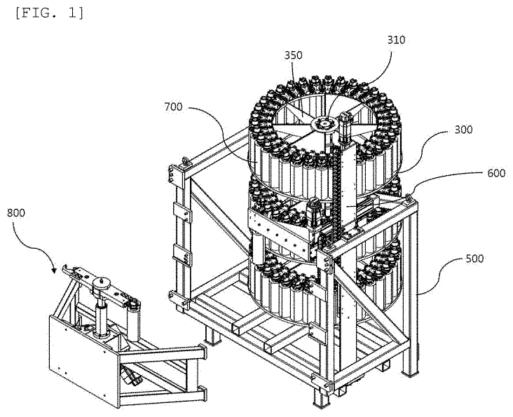

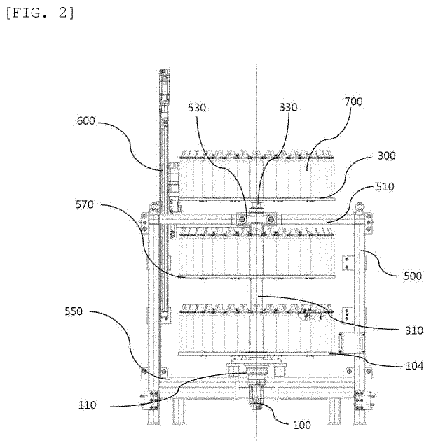

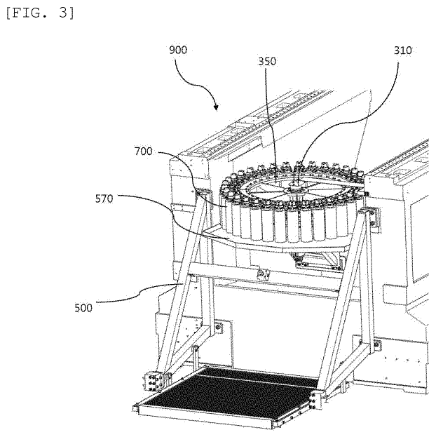

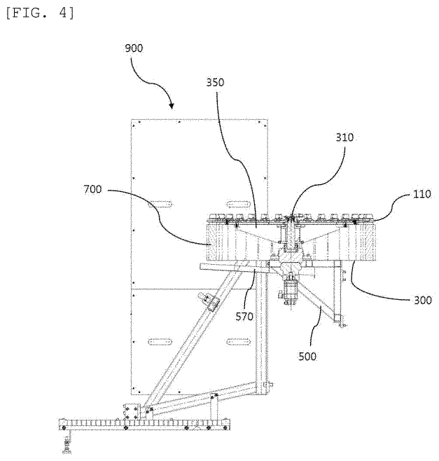

FIG. 1 is a view illustrating a tool magazine module of a machine tool according to a first exemplary embodiment of the present invention, FIG. 2 is a side view of FIG. 1, FIG. 3 is a view illustrating the tool magazine module of the machine tool according to a second exemplary embodiment of the present invention, and FIG. 4 is a side view of FIG. 3.

In the present invention, the first exemplary embodiment describes a twin-arm-type automatic tool changer as an example, and the second exemplary embodiment describes a pickup-type automatic tool changer as an example. In the present invention, without a separate design change, both the twin-arm type and the pickup type may be applicable. Particularly, in the present invention, while the twin-arm type is used for the description, the main concept is that a plurality of tool magazines is stacked and used. Therefore, the description will be illustrated with reference to the drawings and explained with an emphasis on that aspect.

As shown in FIGS. 1 and 2, according to the exemplary embodiments of the present invention, the tool magazine module of the machine tool includes: a rotary shaft 310, rotating by being connected to a drive part 100 providing a rotational force; a plurality of magazine bases 300 having a disk shape and being provided with a central part connected to the rotary shaft 310 to be rotated, the plurality of magazine bases loaded with a tool 700 along a rim, and mounted by being stacked on the rotary shaft 310; and a transfer system 600 enabling the tools 700 to be interchanged between any magazine base 300 and a tool changer 800 by moving in an up-and-down direction and a forward-and-backward direction on one side of the magazine base 300.

The magazine base 300 of the present invention has a disk shape, the central part of which is connected to the rotary shaft 310 and rotated. The rotary shaft 310 is connected to a drive part 100 that provides a rotational force and rotated, and the details will be described later. The drive part 100 may be a conventional motor. In particular, the magazine base 300 is provided in a ring shape having a cavity therein, and the rotary shaft 310 is inserted into the cavity and rotatably connected thereto. The rotary shaft 310 is provided with a support part 350 extending radially from the rotary shaft 310 to the magazine base 300 and connecting therebetween, so that rotation is supported when the magazine base 300 is rotated, and thus the rotation may be more stably performed.

When the tool 700 is loaded on the magazine base 300, the tool 700 is loaded along a rim of the magazine base 300, and neighboring tools 700 are loaded close to each other by being loaded vertically. Therefore, unlike the radially loaded tools in the conventional disk-shaped magazine base, the tools are loaded vertically, thereby having a benefit of making it possible to load a larger number of tools. In addition, the magazine base 300 to which such a tool 700 is loaded is composed in the same form, and a plurality of magazine bases is stacked, and thus a larger number of tools 700 may be loaded. In addition, the magazine base 300 has no restriction on the number of layers thereof, thereby having a benefit in that magazine bases 300 may be easily added to the stack or removed therefrom without need for identifying the location thereof.

In particular, the magazine base 300 is rotated when driving the drive part 100, wherein the magazine base 300 is provided with a rotary shaft 310 that is inserted through the plurality of magazine bases 300 so as to rotate the magazine bases 300, wherein the drive unit 100 is provided with the drive shaft 110, which is rotated when the drive part 100 is driven, and wherein the drive shaft 110 and the rotary shaft 310 are connected, whereby the plurality of magazine bases 300 may be simultaneously rotated when the drive part 100 is driven. In addition, since the base plate 570 is provided at a position below the magazine base 300 to collect leftover cutting oil that drops when changing the tools 700, the oil falling from the upper-layer magazine base 300 does not affect the lower-layer magazine base 300, making it possible to maintain the tool 700 in an optimal state, free from contamination by foreign matter.

In the magazine base 300, by being extended in an up-and-down direction in the outer side or the periphery of the magazine base 300, a frame 500 is provided, enclosing and supporting the magazine bases 300 stacked in a plurality thereof. That is, the plurality of magazine bases 300 is stacked and installed on the frame 500. The frame 500 may be provided by connecting a plurality of bar-shaped links to each other. Outside the frame 500, an independently configured tool changer 800 is positioned, and the machine tool 900 is positioned outside the tool changer 800, wherein both the tool changer 800 and the machine tool 900 are connected to the magazine base 300 mounted on the frame 500 so that the tool 700 provided in the magazine base 300 may be supplied to the machine tool 900 by the tool changer 800. At this time, at least half of the magazine base 300 is inserted into and coupled to the inside of the machine tool 900, and thus there is a benefit in that it becomes easy to change the tool 700 in the tool changer 800. In addition, in the production process, there is an advantage in that the tool magazine module, the machine tool 900, and the tool changer 800 may be assembled independently of each other.

A support plate 550 is provided at a position below the frame 500, and the support plate 550 is provided to maintain the center of rotation when the drive part 100 rotates. The drive shaft 110 of the drive part 100 is vertically connected to the rotary shaft 310 provided through the plurality of magazine bases 300. Accordingly, when rotating the drive part 100, the drive shaft 110 is rotated, and the rotary shaft 310, which is integrally provided with the drive shaft 110, is also rotated, and thus the magazine base 300 is rotated.

The transfer system 600 is provided at a position on one side of the frame 500 and is moved in an up-and-down direction and a forward-and-backward direction on one side of the magazine base 300, so that the tool 700 may be interchanged between any magazine base 300 and a tool changer 800.

In FIGS. 1 and 2, illustrating the first exemplary embodiment of the present invention, the magazine base 300 is illustrated as an example that is stacked in three layers. In this case, it may be difficult to rotate the magazine base while maintaining the center of rotation and the vertical state of both the drive shaft 110 of the drive part 100 and the rotary shaft 310 provided so as to be vertically connected to the drive shaft 110. Therefore, in the present invention, a transverse frame 510 is provided at a position between the two magazine bases 300 mounted from below the frame 500 and the other magazine base 300 so as to support the rotary shaft 310. The transverse frame 510 extends toward the rotary shaft 310 in a direction crossing the rotary shaft 310 from the frame 500 provided in an up-and-down direction. Another rotary shaft 330 is inserted through the extended transverse frame 510. At this time, a bearing part 530 is provided at a position between the rotary shaft 330 and the transverse frame 510, thereby enabling the rotary shaft 330 inserted into the transverse frame 510 to be rotated.

Accordingly, the drive shaft 110 is rotated when driving the drive part 100, and the rotary shaft 310 is rotated according to the rotation of the drive shaft 110, wherein, when a predetermined number of magazine bases are to be stacked, another rotary shaft 330 is provided by vertically penetrating and being connected to the transverse frame 510 so as to maintain the center of rotation, so that when driving the drive part 100, the plurality of magazine bases 300 is rotated while maintaining the center of rotation in a vertically stacked state. Therefore, even when magazine bases 300 are stacked on the frame 500 one after another, the transverse frame 510 is provided at the positions in between the intervals so that the center of rotation (in short, the center) formed by the drive shaft 110 of the drive part 100 is maintained while the rotary shaft 310 and 330 is supported, whereby the magazine base 300 is able to rotate more stably.

FIGS. 3 and 4 illustrate a case where the magazine base 300 having a pickup-type tool change method is provided. As in the first exemplary embodiment, the tool 700 is loaded on the magazine base 300, and the frame 500 is provided at a position outside the magazine base 300. However, in the second exemplary embodiment, the magazine base 300 on which the tool 700 is loaded is composed of a single layer so that about half of the magazine base 300 is inserted into the machine tool 900. In addition, the magazine base 300 is coupled to the frame 500 and is directly bound to the machine bed 400 of the machine tool 900, thereby composing a pickup-type automatic tool-change system. In the case of such a pickup type, a base plate 570 is provided on one side of the frame 500 to receive cutting oil or foreign matter.

Therefore, according to the tool magazine module of the machine tool of the present invention as described above, regardless of whether the automatic tool changer implements a twin-arm type or a pickup type, the tool magazine module may be applied without an additional design change. In particular, in the case of the twin-arm type, simply by increasing or decreasing the number of magazine bases, the twin-arm type has a benefit of increasing the limited tool capacity, which is a disadvantage of the conventional disk magazine. Therefore, the diversity of the product may be maintained while reducing the development and production cost of the magazine base, and the tool magazine module has a benefit in that it is capable of being easily applied to any machine tool merely by changing a stacked number thereof according to the size and shape of the machine tool.

As described above, the present invention has been described with reference to particular exemplary embodiments thereof. However, those skilled in the art will appreciate that various modifications, additions and substitutions are possible, without departing from the scope and spirit of the invention as disclosed in the accompanying claims.

### DESCRIPTION OF THE REFERENCE NUMERALS IN THE DRAWINGS

| | |
|---|---|
| 100: drive part | 110: drive shaft |
| 300: magazine base | 310, 330: rotary shaft |
| 350: support part | 400: machine bed |
| 500: frame | 510: transverse frame |
| 530: bearing part | 550: support plate |
| 570: base plate | 600: transfer system |
| 700: tool | 800: tool changer |
| 900: machine tool | |

1. A tool magazine module of a machine tool, the tool magazine module comprising:
a rotary shaft rotating by being connected to a drive part providing a rotational force;
a plurality of magazine bases having a disk shape and being provided with a central part connected to the rotary shaft to be rotated, the plurality of magazine bases loaded with tools along a rim thereof, and mounted by being stacked on the rotary shaft; and
a transfer system enabling the tools to be interchanged between any magazine base and a tool changer by moving in an up-and-down direction and a forward-and-backward direction on one side of the magazine base.

2. The tool magazine module of claim 1, wherein the tools are loaded vertically with respect to the magazine base, so that neighboring tools are provided in close contact with each other.

3. The tool magazine module of claim 1, wherein the magazine base is provided in a ring shape having a cavity, the rotary shaft is inserted into the cavity and is rotatably connected thereto, and the rotary shaft is provided with a support part extending radially from the rotary shaft to the magazine base and connecting therebetween so as to support rotation of the magazine base.

4. The tool magazine module of claim 1, wherein the magazine base is provided with the rotary shaft for rotating the magazine base by insertion through the plurality of magazine bases, and the drive part is provided with a drive shaft that is rotated when driving the drive part; and wherein the drive shaft and the rotary shaft are connected, so that the plurality of magazine bases rotates simultaneously when driving the drive part.

5. The tool magazine module of claim 1, wherein the magazine base is provided with a frame that wraps and supports the magazine bases, stacked in a plurality thereof, and extending in an up-and-down direction from an outer side or periphery of the magazine bases.

6. The tool magazine module of claim 5, wherein the frame is provided with a transverse frame positioned between the magazine bases stacked and extending toward the rotary shaft in a direction crossing the rotary shaft, and the rotary shaft is inserted through the transverse frame, so that the rotary shaft is supported by the transverse frame when driving the drive part and is rotated while a center of rotation is maintained.

7. The tool magazine module of claim 6, wherein a bearing part is provided at a position between the rotary shaft and the transverse frame to enable rotation of the rotary shaft inserted into the transverse frame.

8. The tool magazine module of claim 6, wherein a support plate is provided at a position below the frame, the support plate is provided to maintain the center of rotation when rotating the drive part, and the drive part is vertically connected to the rotary shaft provided through the plurality of magazine bases; and wherein, when more than a predetermined number of magazine bases is stacked, another rotary shaft is provided to penetrate vertically through and be connected to the transverse frame to maintain the center of rotation, so that, when driving the drive part, the plurality of magazine bases in a vertically stacked state is rotated while maintaining the center of rotation.

9. The tool magazine module of claim 5, wherein the tool changer is positioned on an outer side of the frame, and the machine tool is positioned on an outer side of the tool changer, and wherein both the tool changer and the machine tool are mounted on the frame and connected to the magazine base.

10. The tool magazine module of claim 1, wherein at least half of the magazine base is inserted into the machine tool and coupled thereto.

11. The tool magazine module of claim 1, wherein a base plate is provided at a position below the magazine base to collect leftover cutting oil that drops when changing the tools.
